(19) United States
(12) Patent Application Publication
(10) Pub. No.: US 2015/0256352 A1
(43) Pub. Date: Sep. 10, 2015

(54) METHOD AND DEVICE FOR SHARING CONTENT BETWEEN DIFFERENT TERMINALS

(71) Applicant: Tencent Technology (Shenzhen) Company Limited, Shenzhen (CN)

(72) Inventors: Bo Yang, Shenzhen (CN); Ning Li, Shenzhen (CN); Jun Xue, Shenzhen (CN); Li Wan, Shenzhen (CN)

(21) Appl. No.: 14/328,115

(22) Filed: Jul. 10, 2014

Related U.S. Application Data
(63) Continuation of application No. PCT/CN2014/072900, filed on Mar. 5, 2014.

(30) Foreign Application Priority Data
Jun. 14, 2014 (CN) 201310234814.7

(51) Int. Cl. H04L 12/18; H04L 29/08

(52) U.S. Cl. CPC H04L 12/1813; H04L 67/147

(57) ABSTRACT

A method for sharing content between different terminals including a first terminal and a second terminal includes: performing following steps by the first terminal: acquiring a terminal list from a server, wherein each of terminals in the terminal list and the first terminal are associated with a same user account; selecting a terminal from the terminal list as the second terminal; and transmitting content to be shared and an indicator of the second terminal to the server.

### CROSS-REFERENCE TO RELATED APPLICATIONS

The present application claims priority to and is a continuation of PCT/CN2014/072900, filed on Mar. 5, 2014 and entitled “METHOD AND DEVICE FOR SHARING CONTENT BETWEEN DIFFERENT TERMINALS”, which claims the priority to Chinese Patent Application No. 201310234814.7, entitled “METHOD AND DEVICE FOR SHARING CONTENT BETWEEN DIFFERENT TERMINALS”, filed on Jun. 14, 2013 with State Intellectual Property Office of People's Republic of China, both of which are incorporated herein by reference in entirety.

### TECHNICAL FIELD

The present invention generally relates to the field of computer communication technology, and in particular to a method and device for sharing content between different terminals.

### BACKGROUND

With the development of computer communication technology, people desire various content sharing (including the share of text, picture, audio, video, etc). However, the content sharing is typically limited. For example, content sharing may be available among same types of devices. More specifically, a mobile phone user may share content with another mobile phone user by sending a short message, and a computer user may share content with another computer user by sending an e-mail. Therefore, there is a need for content sharing among different types of devices.

### SUMMARY

The invention provides a method and device for sharing content between different types of terminals, so as to achieve improved flexibility of the content sharing.

A method for sharing content between different terminals, where the different terminals include a first terminal and a second terminal, and the method includes: performing following steps by the first terminal: acquiring a terminal list from a server, where each of terminals in the terminal list and the first terminal are associated with a same user account or are linked to the same user account; selecting a terminal from the terminal list as the second terminal; and transmitting content to be shared and an indicator of the second terminal to the server, where the server transmits the content to be shared to the second terminal according to the indicator, where the content to be shared is at least part of the content or the content to be shared is a resource locator pointing to the content.

A method for sharing content between different terminals, including: transmitting a broadcast message for a predetermined port to a local area network where the first terminal resides; generating a terminal list of terminals responding to the broadcast message; selecting a terminal from the terminal list as a second terminal; and transmitting content to be shared to the predetermined port of the second terminal, where the content to be shared is at least part of the content or the content to be shared is a resource locator pointing to the content.

An apparatus for sharing content between different terminals, including: a terminal list acquiring module, configured to acquire a terminal list from a server, where each of terminals in the terminal list and the first terminal are associated with a same user account or are linked to the same user account; a second terminal selecting module, configured to select a terminal from the terminal list as a second terminal; and a content sharing module, configured to transmit content to be shared and an indicator of the second terminal to the server, where the server transmits the content to be shared to the second terminal according to the indicator, where the content to be shared is at least part of the content or a resource locator pointing to the content.

An apparatus for sharing content between different terminals, including: a broadcasting module, configured to transmit a broadcast message for a predetermined port to a local area network where the first terminal resides; a terminal list generating module, configured to generate a terminal list of terminals responding to the broadcast message; a second terminal acquiring module, configured to select a terminal from the terminal list as a second terminal; and a content transmitting module, configured to transmit content to be shared to the predetermined port of the second terminal, where the content to be shared is at least part of the content or a resource locator pointing to the content.

According to the above-mentioned method and device for sharing content between different terminals, a list of other terminals which are associated with a same user account as a first terminal is acquired from a server. The content to be shared is pushed by the server to a second terminal which is selected from the terminal list in response to a second input operation. The content to be shared may be pushed to different types of terminal devices, so that the range of the content sharing is enlarged and the flexibility of the content sharing is improved.

To make the above-mentioned and other objects, features and advantages of the disclosure more obvious and easy to understand, preferable embodiments of the disclosure are illustrated in detail in conjunction with the drawings in the following.

### BRIEF DESCRIPTION OF THE DRAWINGS

FIG. 1 illustrates a structural block diagram of a terminal according to the teachings of the present disclosure;

FIG. 2a is a flowchart of a method, which is applied in a terminal, for sharing content between different terminals according to a first embodiment of the disclosure;

FIG. 2b is a flowchart of a method, which is applied in a terminal, for sharing content between different terminals according to an embodiment of the disclosure;

FIG. 3 is a schematic view showing first application environment for the flowchart of the method, which is applied in a terminal, for sharing content between different terminals according to the first embodiment of the disclosure;

FIG. 4 is a flowchart of a method, which is applied in a terminal, for sharing content between different terminals according to a second embodiment of the disclosure;

FIG. 5 is a schematic diagram of a first operation of the method, which is applied in a terminal, for sharing content between different terminals according to the second embodiment of the disclosure;

FIG. 6 is a schematic diagram of a second operation of the method, which is applied in a terminal, for sharing content between different terminals according to the second embodiment of the disclosure;

FIG. 7 is a schematic diagram of a third operation of the method, which is applied in a terminal, for sharing content between different terminals according to the second embodiment of the disclosure;

FIG. 8 is a schematic flowchart of a method, which is applied in a terminal, for sharing content between different terminals according to a third embodiment of the disclosure;

FIG. 9 is a schematic view showing second application environment for the flowchart of the method, which is applied in a terminal, for sharing content between different terminals according to the third embodiment of the disclosure;

FIG. 10a is a schematic flowchart of a method, which is applied in a terminal, for sharing content between different terminals according to a fourth embodiment of the disclosure;

FIG. 10b is a schematic flowchart of a method for sharing content between different terminals according to an embodiment of the disclosure;

FIG. 11 is a schematic structural diagram of an apparatus, which is applied in a terminal, for sharing content between different terminals according to a fifth embodiment of the disclosure;

FIG. 12 is a schematic diagram of storage environment of the apparatus in FIG. 11;

FIG. 13 is a schematic structural diagram of an apparatus, which is applied in a terminal, for sharing content between different terminals according to a sixth embodiment of the disclosure;

FIG. 14 is a schematic structural diagram of an apparatus, which is applied in a terminal, for sharing content between different terminals according to a seventh embodiment of the disclosure;

FIG. 15 is a schematic structural diagram of an apparatus for sharing content between different terminals according to an embodiment of the disclosure; and

FIG. 16 is a schematic structural diagram of an apparatus for sharing content between different terminals according to another embodiment of the disclosure.

### DETAILED DESCRIPTION OF THE EMBODIMENTS

The embodiments, structures, features and the function of the disclosure are described in detail in conjunction with the drawings and preferable embodiments as follows, in order to further describe the technical solution for achieving the predetermined inventive object and the function of the disclosure.

The method for sharing content between different terminals according to the embodiments of the disclosure is applied to a terminal to allow for content sharing among different terminals of the same type or different types. The terminals may include, but not be limited to, smart phones, tablet PCs, e-book readers, MP3 players (Moving Picture experts Group Audio Layer III), MP4 (Moving Picture Experts Group Audio Layer IV) players, portable laptop computers, desktop computers.

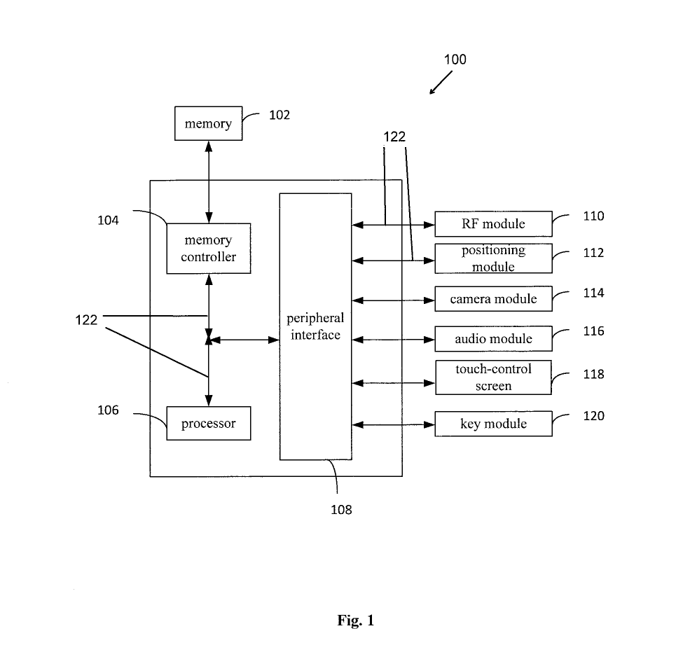

Referring to FIG. 1 which shows a structural block diagram of a terminal, the terminal 100 includes a memory 102, a memory controller 104, one or more (only one is shown) processors 106, a peripheral interface 108, a radio frequency module 110, a positioning module 112, a camera module 114, an audio module 116, a touch-control screen 118 and a key module 120. These components communicate with each other through one or more communication buses/signal lines 122.

It should be understood that the structure shown in FIG. 1 is only for illustrative purposes, and thus more or fewer components than those shown in FIG. 1 may be provided in the terminal 100 or the terminal 100 may have a different configuration from that shown in FIG. 1. Each of the components shown in FIG. 1 may be implemented hardware, software or the combination thereof.

The memory 102 may be used in the terminal 100 to store software programs and the modules, such as program instructions/modules corresponding to the method and device, for sharing content between different terminals according to the embodiments of the disclosure. The term “different terminals”, as used throughout the present disclosure, refers to same or different types of terminals. The processor 106 may perform various function applications and data processes, i.e. implement the above-mentioned method, for sharing content between different terminals, by running the software programs and modules stored in the memory 102.

The memory 102 may include a high-speed random access memory and may also include a nonvolatile memory, such as one or more magnetic storage devices, flash memories or other non-volatile solid-state memories. In some examples, the memory 102 may further include a memory remotely arranged with respect to the processor 106. The remote memory may be connected to the terminal 100 via a network. Examples of the networks include, but are not limited to, the Internet, an intranet, a local area network, a mobile communication network and any combination thereof. The processor 106 and other possible components may access the memory 102 under the control of the memory controller 104.

The peripheral interface 108 may couple various input/output devices to the CPU and the memory 102. The processor 106 performs various functions of the terminal 100 and the data processing by running the software and instructions in the memory 102.

In some embodiments, the peripherals interface 108, the processor 106 and the memory controller 104 may be provided in a single chip. In some other embodiments, the peripherals interface 108, the processor 106 and the memory controller 104 may be provided in separate chips.

The radio frequency (RF) module 110 is used for receiving and transmitting electromagnetic waves and provides the inter-conversion between the electromagnetic wave and the electrical signal, to provide communication between the communication network and/or other apparatus. The radio frequency module 110 may include a variety of circuit elements for performing these functions, such as an antenna, a radio frequency transceiver, a digital signal processor, an encryption/decryption chip, a subscriber identity module (SIM) card and a memory. The radio frequency module 110 may communicate with a variety of networks, such as the Internet, the intranet and wireless network or may communicate with other apparatus via a wireless network. The wireless network may include a cellular telephone network, a wireless local area network or a metropolitan area network. The wireless network may use a variety of communications standards, protocols and technologies, including, but not limited to, the Global System for Mobile communication system (GSM), the enhanced data GSM environment (EDGE), the wideband code division multiple access (W-CDMA), the code division multiple access (CDMA), the time division multiple access (TDMA), the Bluetooth, the Wireless Fidelity (WiFi) (such as the American Institute of Electrical and Electronics Engineers Association standards IEEE 802.11a, IEEE 802.11b, IEEE802.11g and/or IEEE 802.11n), the Voice over internet protocol (VoIP), the Worldwide Interoperability for Microwave Access (Wi-Max), other protocol for mail, instant messaging and short message and any other suitable communication protocol, even a protocol which has no not been developed yet.

The positioning module 112 is used to acquire the current position of the terminal 100. The examples of the positioning module 112 include, but are not limited to, a global satellite positioning system (GPS), a wireless-local-area-network or mobile-communication-network based positioning technology.

The camera module 114 is used to take photos or videos. The photos or videos may be stored into the memory 102 and may be transmitted through the radio frequency module 110.

The audio module 116 may provide an audio interface to the user. The audio module 116 may include one or more microphones, one or more speakers and an audio circuit. The audio circuit receives audio data from the peripheral interface 108, converts the audio data into electrical information and transmits the electrical information to the speaker. The speaker converts the electrical information into sound waves which are audible by the human ear. The audio circuit also receives electrical information from the microphone, converts the electrical signals into sound data and transmits the sound data into the peripheral interface 108 for further processing. The audio data may be acquired from the memory 102 or through the radio frequency module 110. Furthermore, the audio data may also be stored in the memory 102 or be transmitted through the radio frequency module 110. In some examples, the audio module 116 may further include a headphone jack for providing an audio interface to a headphone or other apparatus.

The touch-control screen 118 provides an output and input interface between the terminal 100 and a user. Specifically, the touch-control screen 118 displays the video output to the user. The content in the video output may include text, image, video and any combination thereof. Some output results correspond to some user interface objects. The touch-control screen 118 also receives input from the user, for example, operation of the user, such as click and sliding, and the user interface object responds to the user input. The technology for detecting the input of the user may be a resistor-based touch detection technology, a capacitor-based touch detection technology or any other possible touch detection technology. The examples of a display unit of the touch-control screen 118 include, but are not limited to, a liquid crystal display or a light emitting polymer display.

The button or key module 120 also provides an interface for the user to input into the terminal 100. The terminal 100 may achieve different functions when the user presses different buttons.

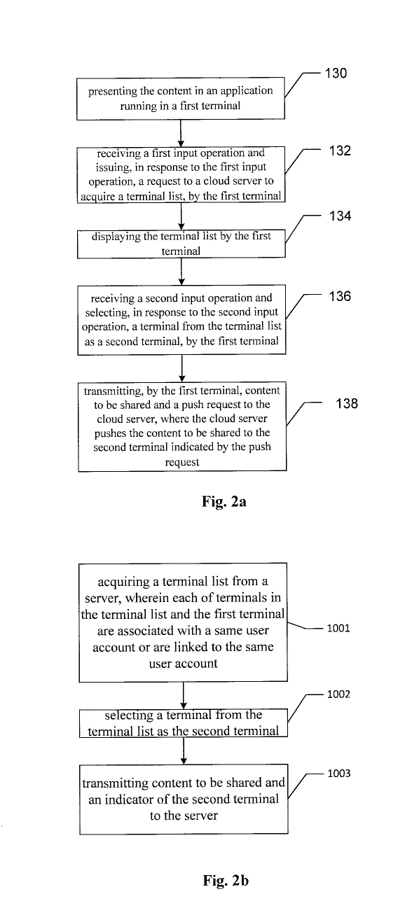

FIG. 2a is a flowchart of a method for sharing content between different terminals according to a first embodiment of the disclosure. As shown in FIG. 2a, the above-mentioned method for sharing content between different terminals includes the following steps.

Step 130: presenting the content in an application running in a first terminal.

Step 132: receiving a first input operation and sending, in response to the first input operation, a request to a cloud server to acquire a terminal list, by the first terminal.

Step 134: displaying the terminal list on the first terminal.

Step 136: receiving a second input operation and selecting, in response to the second input operation, a terminal from the terminal list as a second terminal, by the first terminal.

Step 138: transmitting, by the first terminal, content to be shared and a push request to the cloud server, where the cloud server pushes the content to be shared to the second terminal indicated by the push request, where the content to be shared is at least part of the content presented in the application or a resource locator pointing to the content presented in the application.

According to the above-mentioned method for sharing content between different terminals, a list of other terminals which are associated with a same user account as a first terminal is acquired from a cloud server. The content to be shared is pushed by the cloud server to a second terminal which is selected from the terminal list in response to a second input operation. The content to be shared may be pushed to different types of terminal devices, so that the range of the content sharing is enlarged and the flexibility of the content sharing is improved.

The above-mentioned method for sharing content between different terminals is described in further detail in conjunction with specific application examples as follows.

FIG. 2b is a flowchart of a method, which is applied in a terminal, for sharing content between different terminals according to an embodiment of the disclosure. As shown in FIG. 2b, the method includes the following steps S1001-S1003.

S1001: acquiring a terminal list from a server, wherein each of terminals in the terminal list and the first terminal are associated with a same user account or are linked to the same user account;

S1002: selecting a terminal from the terminal list as the second terminal; and

S1003: transmitting content to be shared and an indicator of the second terminal to the server, wherein the server transmits the content to be shared to the second terminal according to the indicator, wherein the content to be shared is at least part of the content or the content to be shared is a resource locator pointing to the content.

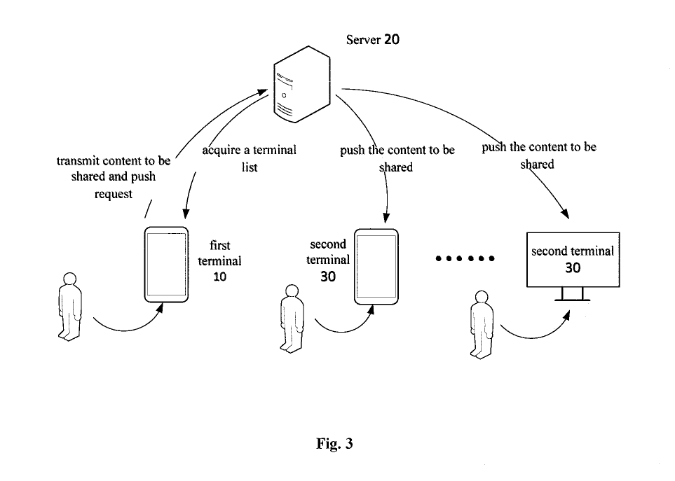

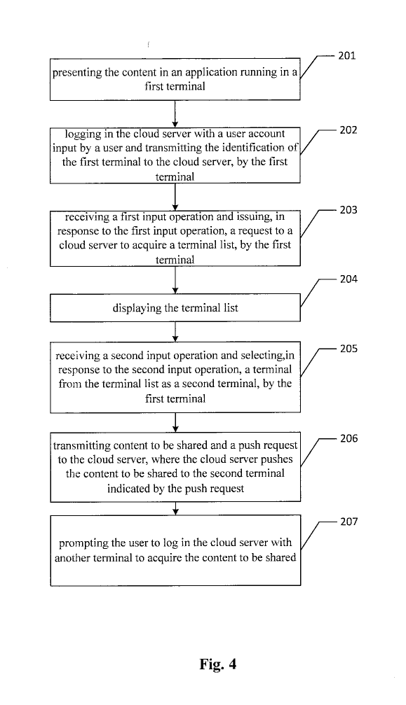

Referring to FIG. 3, which shows an exemplary application environment of the embodiment, the first terminal 10 pushes content to be shared to one or more second terminals 30 through a server 20 via a wired or wireless network. The second terminal 30 may be the same type as the first terminal 10 or a different type from the first terminal 10. For example, the first terminal 10 may be a smart phone, and the second terminal 30 may also be a smart phone or may be a Tablet PC, an e-Book reader, a portable laptop computer, a desktop computer etc.

The application in Step 130 may be, for example, a browser. The content presented in the application may include, as can be understood, text, image, audio, video and any combination thereof. The above-mentioned content may be stored in the first terminal 10. Alternatively, the above-mentioned content may be stored in the cloud server 20 or other cloud storage server. If the above-mentioned content is stored in the cloud server 20 or other cloud storage server, the first terminal 10 acquires and presents the content to the user from the cloud server 20 or other cloud storage server by using the uniform resource locator (URL) of the above-mentioned content.

In Step 132, each of the terminals in the terminal list and the first terminal are associated with the same user account or linked to the same user account. In other words, each of the terminals in the terminal list has direct or indirect association with the first terminal. In particular, each of the terminals in the terminal list may be directly associated with the first terminal by being bound to the same account, and all the terminals log in the cloud server by using the same user account. Alternatively, although each of the terminals in the terminal list and the first terminal do not have direct association with each other and log in the cloud server by using respective user accounts, these user accounts may be associated with each other in a social networking service (SNS) and thereby may be indirectly associated with each other. For example, these terminals may be in a mutual-friend relationship. Because of the above-mentioned association between each of the terminals in the terminal list with the first terminal, the first terminal may share information with each of the terminals in the terminal list.

It should be understood that the push request in Step 138 includes at least an identification of the second terminal selected in response to the second input operation in Step 136. The cloud server 20 pushes the content to be shared to the second terminal according to the identification of the second terminal.

The content to be shared may include at least part of the content presented in the first terminal 10 or a URL pointing to the content presented in the first terminal, such as, the URL of a page presented in the first terminal, the URL of an audio or video file in a page presented in the first terminal or an audio or video file presented in the first terminal. When the content to be shared is the URL of the content, the second terminal 30 downloads and displays the content to be shared from the server according to the received URL. When the content to be shared is an audio or video file, the second terminal 30 receives and directly displays the content to be shared.

FIG. 4 is a flowchart of a method for sharing content between different terminals according to a second embodiment of the disclosure. As shown in FIG. 4, the method for sharing content between different terminals according to the embodiment includes the follows steps.

Step 201: displaying the content in an application running in a first terminal.

Step 202: logging in the cloud server with a user account input by a user and transmitting the identification of the first terminal to the cloud server, by the first terminal.

It may be understood that, in addition to the user account, the cloud server may also be logged in with other information input by the user for indicating the identity of the user, such as a telephone number, a nickname and an e-mail address used when the user registers with the cloud server.

Step 203: receiving a first input operation and sending, in response to the first input operation, a request to a cloud server to acquire a terminal list, by the first terminal, where each of terminals in the terminal list and the first terminal are associated with a same user account.

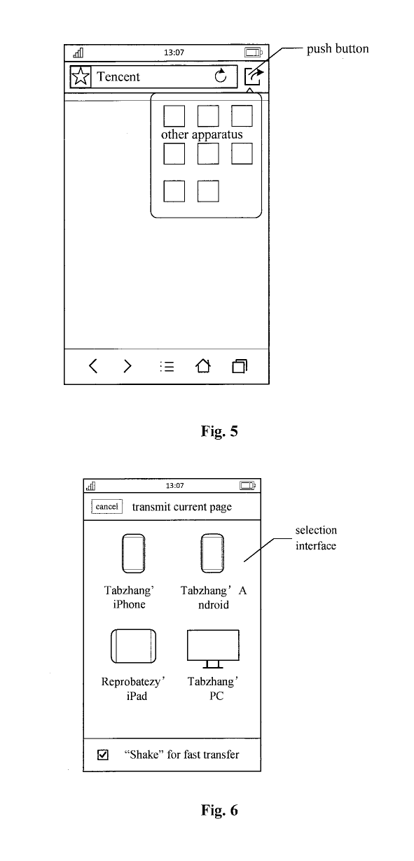

For example, the first terminal may receive a first input operation performed by a user on a browser shown in FIG. 5 (for example, the operation of the user to click a push button in a toolbar on the browser), to send a request to the cloud server to obtain a terminal list. Each of the terminals in the terminal list and the first terminal are associated with a same user account, i.e., the user account input by the user in step 202. Each of the terminals in the terminal list and the first terminal log in the cloud server with the same account. As for the association, for example, when the cloud server detects that the second terminal logs in the cloud server by using said same user account for the first time, the cloud server may acquire the identification of the second terminal and associate the identification of the second terminal with the user account. It should be understood that the cloud server may also associate the second terminal with the same user account in response to an instruction from the user. For example, the user may input the identification of the second terminal in an association interface to associate the second terminal with said same user account.

It should be noted that, in other example of the embodiment, the first terminal logs in the cloud server by using the first user account, and each of the terminals in the terminal list logs in the cloud server by using other different user accounts. These different user accounts are linked to the first user account in a social network SNS. For example, the other different user accounts may be linked to the first user account because the other different user accounts and the first user account are in a mutual-SNS-friend relationship. The first user account is authorized to share content with the other different user accounts based on the authorization set by the other different user accounts. For example, if a user account A and a user account B are in the mutual-SNS-friend relationship, a first terminal using the user account A may push content to be shared with a second terminal using the user account B in the terminal list when the user account A is authorized by the user account B. It should be understood that when the first user account is authorized by a third party user account associated with another different user account, the first terminal using the first user account may also push the content to be shared with a terminal using the another different user account in the terminal list. For example, if a user account A and a user account B are both associated accounts belonging to a user A and the user A often logs in the cloud server at home by using the user account B, the user A, login in the cloud server with the user account A, may authorize the user account C to push the content to be shared with the user account B during non-working period and to push the content to be shared with the user account A during working period. In this way, it can be avoided that the user A may not obtain in a timely manner the pushed content to be shared due to the personal habit. The terminals binding respectively with different user accounts may be associated with each other by using the SNS-friend relationship, so that the content may be shared by different accounts, thereby further enlarging the range of the content sharing and improving the flexibility of the content sharing.

Step 204: displaying the terminal list.

Step 205: receiving a second input operation and selecting, in response to the second input operation, a terminal from the terminal list as a second terminal, by the first terminal.

For example, as shown in FIG. 6, a terminal list displayed in a selection interface of a browser includes at least identification (e.g. Tabzhang) and a type (e.g. PC, iPhone) of each terminal to distinguish one terminal from another. The first terminal receives a second input operation performed by the user on the selection interface and selects in response to the second input operation a terminal from the terminal list as a second terminal.

Step 206: transmitting content to be shared and a push request to the cloud server, where the cloud server pushes the content to be shared to the second terminal indicated by the push request, where the content to be shared is at least part of the content presented in the application or a resource locator pointing to the content presented in the application.

Step 207: prompting the user to log in the cloud server with another terminal to acquire the content to be shared.

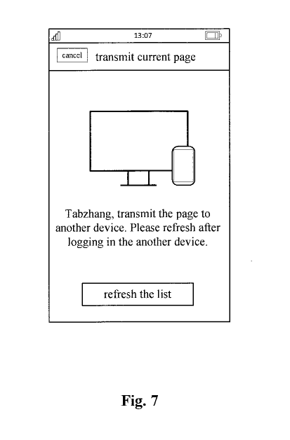

When the second terminal has not yet logged in the cloud server, for example, as shown in FIG. 7, a prompting information is displayed in the browser for prompting the user to log in the cloud server with the second terminal to acquire the content to be shared and display the content to be shared with a second browser of the second terminal.

It should be understood that when the second terminal logs in the cloud server, the above-mentioned information for prompting the user to log in the cloud server may not be displayed and only information for prompting success transmission is displayed, or no prompting information is displayed.

According to the above-mentioned method for sharing content between different terminals, a list of other terminals which are associated with a same user account as a first terminal is acquired from a cloud server. The content to be shared is pushed by the cloud server to a second terminal which is selected from the terminal list in response to a second input operation. The content to be shared may be pushed to different types of terminal devices, so that the range of the content sharing is enlarged and the flexibility of the content sharing is improved.

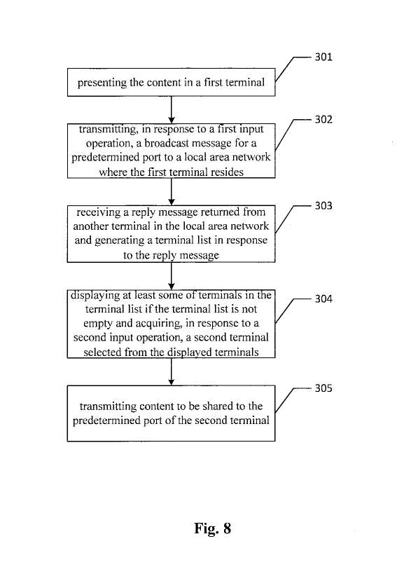

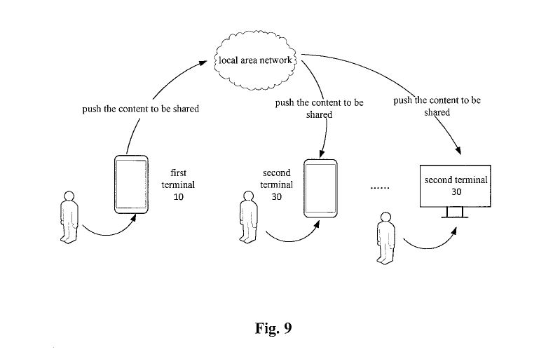

FIG. 8 is a schematic flowchart of a method for sharing content between different terminals according to a third embodiment of the disclosure. As shown in FIG. 8, the above-mentioned method for sharing content between different terminals includes the following steps.

Step 301: presenting the content in a first terminal;

Step 302: transmitting, in response to a first input operation, a broadcast message for a predetermined port to a local area network where the first terminal resides;

Step 303: receiving a reply message returned from another terminal in the local area network and generating a terminal list in response to the reply message;

Step 304: displaying at least some of terminals in the terminal list if the terminal list is not empty and acquiring, in response to a second input operation, a second terminal selected from the displayed terminals; and

Step 305: transmitting content to be shared to the predetermined port of the second terminal, where the content to be shared is at least part of the content presented in the first terminal or a resource locator pointing to the content presented in the first terminal.

According to the above-mentioned method for sharing content between different terminals, a broadcast message for a predetermined port is transmitted to a local area network where the first terminal resides; a terminal list is generated in response to a reply message returned from another terminal in the local area network; and content to be shared is transmitted to the predetermined port of the second terminal in response to a second input operation. In this way, the content to be shared may be pushed to different types of terminal devices in the local area network, so that the content may be shared between different networks, thereby further enlarging the range of the content sharing and improving the flexibility of the content sharing.

The above-mentioned method for sharing content between different terminals is described in further detail in conjunction with specific application examples as follows.

Referring to FIG. 9, which shows exemplary application environment of the embodiment, the first terminal 10 pushes content to be shared to one or more second terminals 30 via a wired or wireless network. It should be understood that the second terminal 30 may be the same type as that the first terminal 10 or different from the first terminal 10. For example, the first terminal 10 may be a smart phone, and the second terminal 30 may also be a smart phone or may be a Tablet PC, an e-Book reader, a portable laptop computer, a desktop computer etc.

The first terminal 10 pushes the content to a target terminal which should also support the content push. For example, an application with a content push function should be installed in the target terminal Otherwise, the content push may not be completed. Moreover, since each application uses a specific port, when the first terminal transmits a broadcast message for a predetermined port to a local area network where the first terminal resides in Step 302, the target terminal, with the application with the content push function being installed, may monitor the broadcast message at the predetermined port and return a reply message in response to the broadcast message, while the target terminal without the application with the content push function being installed may not return any reply message. In this way, a terminal which dose not support the content push may be ignored, thereby shortening the time spent in searching for the target terminal and improving the efficiency of the push.

It should be understood that the content mentioned in Step 301 may include text, image, audio, video and any combination thereof.

The reply message mentioned in Step 303 may include the identification and an internet protocol (IP) address of the terminal which sends the reply message.

In Step 305, the first terminal transmits the content to be shared with the second terminal selected in Step 304, based on the IP address included in the acquired reply message returned from the second terminal in Step 303.

The content to be shared may include at least part of the content presented in the first terminal or a resource locator pointing to the content presented in the first terminal, such as, the resource locator of a page presented in the first terminal, the resource locator of an audio or video file in a page presented in the first terminal or an audio or video file presented in the first terminal.

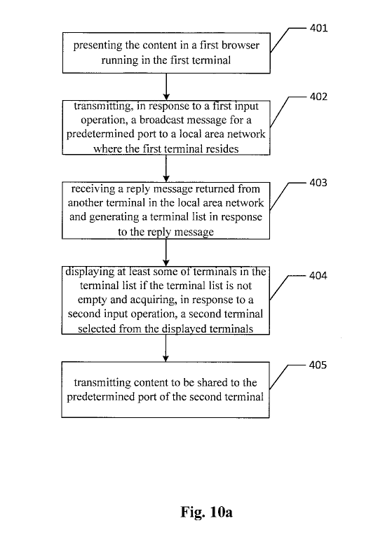

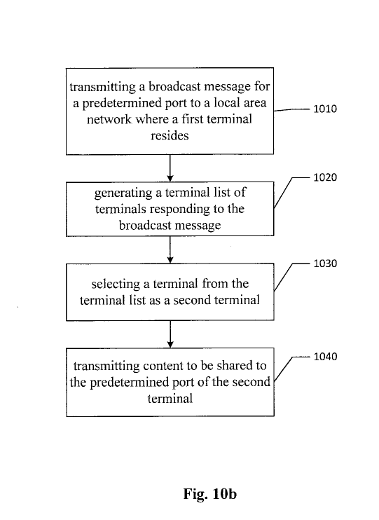

FIG. 10a is a schematic flowchart of a method for sharing content between different terminals according to a fourth embodiment of the disclosure. As shown in FIG. 10a the above-mentioned method for sharing content between different terminals includes the following steps.

Step 401: presenting the content in a first browser running in the first terminal.

Step 402: transmitting, in response to a first input operation, a broadcast message for a predetermined port to a local area network where the first terminal resides;

Step 403: receiving a reply message returned from another terminal in the local area network and generating a terminal list in response to the reply message;

Step 404: displaying at least some of terminals in the terminal list if the terminal list is not empty and acquiring, in response to a second input operation, a second terminal selected from the displayed terminals.

Steps 402 to 404 are similar to Steps 302 to 304 described in the third embodiment and the description thereof is omitted herein.

Step 405: transmitting content to be shared with the predetermined port of the second terminal, where the content to be shared is at least part of the content presented in the first terminal or a resource locator pointing to the content presented in the first terminal.

The second terminal receives, via the predetermined port, the content to be shared and transmitted from the first terminal, and presents the content to be shared with a second browser running in the second terminal.

According to the above-mentioned method for sharing content between different terminals, a broadcast message for a predetermined port is transmitted to a local area network where the first terminal resides; a terminal list is generated in response to a reply message returned from another terminal in the local area network; and content to be shared is transmitted to the predetermined port of the second terminal in response to a second input operation. In this way, the content to be shared may be pushed to different types of terminal devices in the local area network, so that the content may be shared by different networks, thereby further enlarging the range of the content sharing and improving the flexibility of the content sharing.

FIG. 10b is a schematic flowchart of a method for sharing content between different terminals according to a fourth embodiment of the disclosure. As shown in FIG. 10b the above-mentioned method for sharing content between different terminals includes the following steps.

S1010: transmitting a broadcast message for a predetermined port to a local area network where a first terminal resides;

S1020: generating a terminal list of terminals responding to the broadcast message;

S1030: selecting a terminal from the terminal list as a second terminal; and

S1040: transmitting content to be shared to the predetermined port of the second terminal, wherein the content to be shared is at least part of the content or the content to be shared is a resource locator pointing to the content.

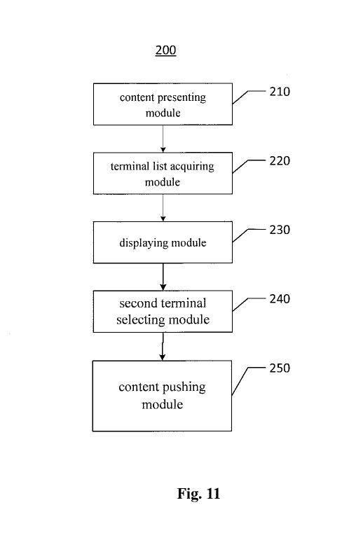

FIG. 11 is a schematic structural diagram of an apparatus for sharing content between different terminals according to a fifth embodiment of the disclosure. The apparatus for sharing content between different terminals according to the embodiment may be used to implement the method for sharing content between different terminals according to the first embodiment. As shown in FIG. 11, the device 200 for sharing content between different terminals includes a content presenting module 210, a terminal list acquiring module 220, a displaying module 230, a second terminal selecting module 240 and a content pushing module 250.

The content presenting module 210 is configured to present the content in an application running in a first terminal.

Preferably, the content includes text, image, audio, video and any combination thereof.

Preferably, the application is a browser.

The terminal list acquiring module 220 is configured to receive a first input operation and issue, in response to the first input operation, a request to a cloud server to acquire a terminal list, where each of terminals in the terminal list and the first terminal are associated with a same user account or are linked to the same user account in a social network.

The displaying module 230 is configured to display the terminal list.

The second terminal selecting module 240 is configured to receive a second input operation and select, in response to the second input operation, a terminal from the terminal list as a second terminal.

The content pushing module 250 is configured to transmit content to be shared and a push request to the cloud server, where the cloud server pushes the content to be shared to the second terminal indicated by the push request, where the content to be shared is at least part of the content presented in the application or a resource locator pointing to the content presented in the application.

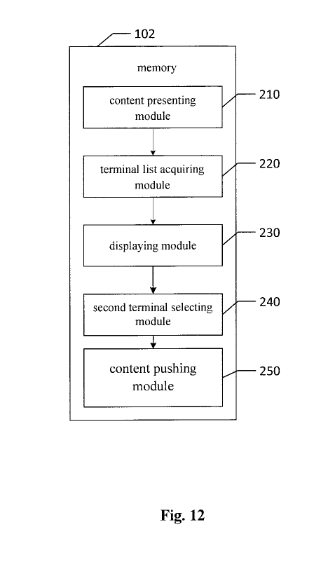

The above-mentioned modules may be implemented by using software. In this case, the above-mentioned modules may be stored in the memory 102, as shown in FIG. 12. The above-mentioned modules may also be implemented by using hardware such an integrate circuit chip.

The various modules of the device 200 according to the present embodiment may implement the various functions and processes similar to those described in connection with FIGS. 1 to 10 and thus the description thereof is omitted herein.

According to the above-mentioned device for sharing content between different terminals, a list of other terminals which are associated with a same user account as a first terminal is acquired from a cloud server. The content to be shared is pushed by the cloud server to a second terminal which is selected from the terminal list in response to a second input operation. The content to be shared may be pushed to different types of terminal devices, so that the range of the content sharing is enlarged and the flexibility of the content sharing is improved.

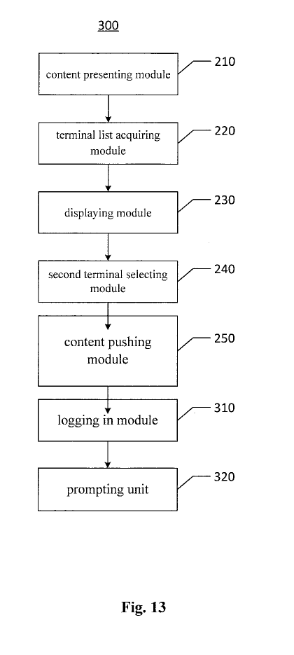

FIG. 12 is a schematic structural diagram of an apparatus for sharing content between different terminals according to a sixth embodiment of the disclosure. The apparatus according to the present embodiment may be used to implement the method described in the second embodiment. As shown in FIG. 13, the image processing device 300 is similar to the device shown in FIG. 12. The image processing device 300 differs from the device shown in FIG. 12 in that the image processing device 300 further includes:

a logging in module 310, configured to log in the cloud server with a user account input by a user and transmit an identification of the first terminal to the cloud server, where the same user account is the input user account; and

a prompting unit 320, configured to prompt a user to log in the cloud server with another terminal to acquire the content to be shared.

Preferably, the content to be shared is presented in the browser running in the second terminal.

Preferably, each of the terminals in the terminal list and the logging in module 310 log in the cloud server with the same account.

Preferably, the logging in module 310 logs in the cloud server with a first user account and any one of the terminals in the terminal list log in the cloud server with another different user account, where the another different user account is linked to the first user account in the social network.

Preferably, the first user account is authorized, according to a permission setting of a different user account, to share content with the different user account.

The various modules of the device 300 according to the present embodiment may implement the various functions described in connection with FIGS. 1 to 10 and thus the description thereof is omitted herein.

According to the above-mentioned device for sharing content between different terminals, a list of other terminals which are associated with a same user account as a first terminal is acquired from a cloud server. The content to be shared is pushed by the cloud server to a second terminal which is selected from the terminal list in response to a second input operation. The content to be shared may be pushed to different types of terminal devices, so that the range of the content sharing is enlarged and the flexibility of the content sharing is improved.

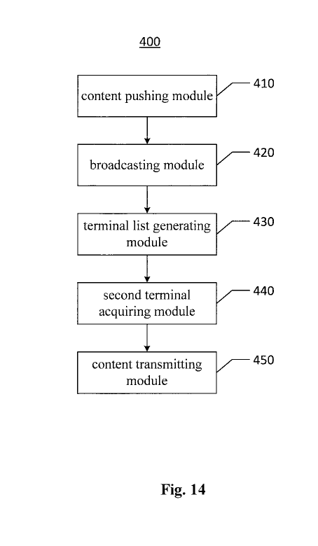

FIG. 14 is a schematic structural diagram of an apparatus for sharing content between different terminals according to a seventh embodiment of the disclosure. The apparatus according to the present embodiment may be used to implement the methods described in the third and fourth embodiments. As shown in FIG. 14, the image processing device 400 for sharing content between different terminals includes a content pushing module 410, a broadcasting module 420, a terminal list generating module 430, a second terminal acquiring module 440 and a content transmitting module 450.

The content pushing module 410 is configured to display the content in a first terminal Preferably, the content includes text, image, audio, video and any combination thereof.

The broadcasting module 420 is configured to transmit, in response to a first input operation, a broadcast message for a predetermined port to a local area network where the first terminal resides.

The terminal list generating module 430 is configured to receive a reply message returned from another terminal in the local area network and generate a terminal list in response to the reply message.

The second terminal acquiring module 440 is configured to display at least some of terminals in the terminal list if the terminal list is not empty and acquire a second terminal selected from the displayed terminals in response to a second input operation.

The content transmitting module 450 is configured to transmit content to be shared to the predetermined port of the second terminal, where the content to be shared is at least part of the content presented in the first terminal or a resource locator pointing to the content presented in the first terminal.

Preferably, the content is displayed with a first browser running in the first terminal.

Preferably, the content to be shared is presented in a second browser running in the second terminal.

The various modules of the device 400 for sharing content between different terminals according to the present embodiment may perform various functions and processes which have been described in connection with FIGS. 1 to 10, and thus the description thereof is omitted herein.

According to the above-mentioned device for sharing content between different terminals, a broadcast message for a predetermined port is transmitted to a local area network where the first terminal resides; a terminal list is generated in response to a reply message returned from another terminal in the local area network; and content to be shared is transmitted to a predetermined port of the second terminal in response to a second input operation. In this way, the content to be shared may be pushed to different types of terminal devices in the local area network, so that the content may be shared by different networks, thereby further enlarging the range of the content sharing and improving the flexibility of the content sharing.

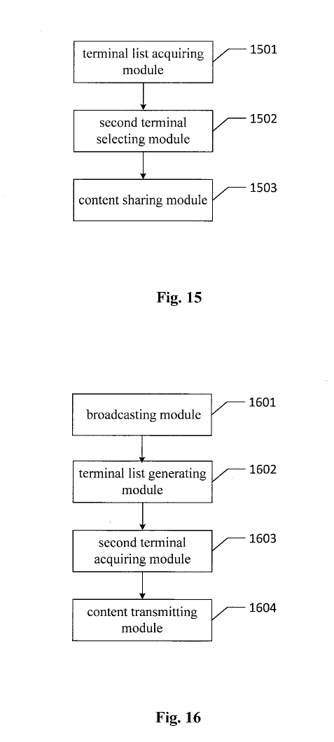

FIG. 15 is a schematic structural diagram of an apparatus for sharing content between different terminals according to an embodiment of the disclosure. As shown in FIG. 15, the apparatus for sharing content between different terminals includes a terminal list acquiring module 1501, a second terminal selecting module 1502, and a content sharing module 1503.

The terminal list acquiring module 1501 is configured to acquire a terminal list from a server, wherein each of terminals in the terminal list and the first terminal are associated with a same user account or are linked to the same user account. The second terminal selecting module 1502, configured to select a terminal from the terminal list as a second terminal. The content sharing module 1503 is configured to transmit content to be shared and an indicator of the second terminal to the server, wherein the server transmits the content to be shared to the second terminal according to the indicator, wherein the content to be shared is at least part of the content or a resource locator pointing to the content.

FIG. 16 is a schematic structural diagram of an apparatus for sharing content between different terminals according to another embodiment of the disclosure. As shown in FIG. 16, the apparatus for sharing content between different terminals includes a broadcasting module 1601, a terminal list generating module 1602, a second terminal acquiring module 1603, and a content transmitting module 1604.

The broadcasting module 1601 is configured to transmit a broadcast message for a predetermined port to a local area network where a first terminal resides. The terminal list generating module 1602 is configured to generate a terminal list of terminals responding to the broadcast message. The second terminal acquiring module 1603 is configured to select a terminal from the terminal list as a second terminal. The content transmitting module 1604 is configured to transmit content to be shared to the predetermined port of the second terminal, wherein the content to be shared is at least part of the content or a resource locator pointing to the content.

It should be noted that the embodiments of the present disclosure are described herein in a progressive manner, with an emphasis placed on explaining the difference between each embodiment and the other embodiments; hence, for the same or similar parts among the embodiments, they can be referred to from one another. For the device disclosed in the embodiments, the corresponding descriptions are relatively simple because the device corresponds to the methods disclosed in the embodiments. The relevant portions may be referred to the description for the method parts.

It should be noted that the relationship terminologies such as first and second and the like are only used herein to distinguish an entity or operation from another entity or operation, and it is not necessarily required or implied that there are any actual relationship or order of this kind among those entities and operations. Moreover, the terminologies of “comprise”, “include”, and any other variants are intended to cover the non-exclusive contains so that the processes, methods, articles or equipment including a series of elements not only include those elements but also include other elements that are not listed definitely or also include the elements inherent in the processes, methods, articles or equipment. In the case of no more restrictions, the elements defined by the statement “include one . . . ” do not exclude that other same elements also exist in the processes, methods, articles or equipment including the elements.

Those of ordinary skilled in the art may understand that all or part of the steps in the above embodiment may be implemented by hardware or be implemented by relevant hardware instructed by programs. The programs may be stored in a computer readable storage media. The aforementioned storage media may be a read only memory, a magnetic disk, an optical disk or the like.

The above-mentioned embodiments are only preferable embodiments of the disclosure and are not intended to limit the disclosure in any form. Preferred embodiments of the present disclosure are disclosed above, which should not be interpreted as limiting the present disclosure. Numerous alternations, modifications and equivalents can be made to the technical solution of the present disclosure by those skilled in the art in light of the methods and technical content disclosed herein without deviation from the scope of the present disclosure. Therefore, any alternations, modifications, and equivalents made to the embodiments above according to the technical essential of the present disclosure without deviation from the scope of the present disclosure should fall within the scope of protection of the present disclosure.

What is claimed is:

1. A method for sharing content between different terminals, comprising:
acquiring, by a first terminal, a terminal list from a server, wherein the terminal list includes a plurality of terminals each being communicable to the first terminal by use of a user account;
selecting a second terminal from the plurality of terminals on the terminal list; and
transmitting, by the first terminal, content to be shared and an indicator of the second terminal to the server, wherein the server transmits the content to be shared with the second terminal according to the indicator.

2. The method according to claim 1, wherein the plurality of terminals on the terminal list each are associated with the first terminal by using the same user account or are linked to the first terminal by linking to the user account.

3. The method according to claim 1, further comprising:
logging in the server with a user account input by a user on the first terminal and transmitting an identification of the first terminal to the server,
wherein each of the plurality of terminals in the terminal list and the first terminal are associated with the user account input by the user or are linked to the user account input by the user.

4. The method according to claim 1, further comprising:
prompting a user of the second terminal to log into the server to acquire the content to be shared.

5. The method according to claim 1, wherein the indicator of the second terminal is included in a push request sent from the first terminal to the server, and the server pushes the content to be shared to the second terminal according to the push request.

6. The method according to claim 1, further comprising: displaying the terminal list for selection of the second terminal.

7. The method according to claim 1, wherein each of the plurality of terminals in the terminal list and the first terminal log in the server with the same user account.

8. The method according to claim 1, wherein the first terminal logs in the server with a first user account and any one of the plurality of terminals in the terminal list log in the server with a second user account, wherein the second user account is linked to the first user account in a social network.

9. The method according to claim 8, wherein the first user account is authorized, according to a permission setting of the second user account, to share content with the second user account.

10. A method for sharing content between different terminals, comprising:
transmitting a broadcast message for a predetermined port to a local area network where a first terminal resides;
generating a terminal list including a plurality of terminals responding to the broadcast message;
selecting a second terminal from the terminal list; and
transmitting content to be shared to the predetermined port of the second terminal.

11. The method according to claim 10, further comprising: displaying the terminal list for selecting the second terminal.

12. The method according to claim 11, further comprising: presenting the content to be shared in a second browser running in the second terminal.

13. The method according to claim 10, wherein the content comprises text, image, audio, video and any combination thereof.

14. The method according to claim 1, wherein the first terminal and the second terminal are of different types.

15. An apparatus for sharing content between different terminals, comprising:
a terminal list acquiring module, configured to acquire a terminal list from a server, wherein the terminal list includes a plurality of terminals each being communicable to the first terminal by use of a user account;
a second terminal selecting module, configured to select a second terminal from the plurality of terminals in the terminal list; and
a content sharing module, configured to transmit content to be shared and an indicator of the second terminal to the server, wherein the server transmits the content to be shared with the second terminal according to the indicator.

16. The apparatus according to claim 15, further comprising:
a logging in module, configured to log in the server with a user account input by a user and transmit an identification of the first terminal to the server, wherein each of terminals in the terminal list and the first terminal are associated with the user account input by the user or are linked to the user account input by the user.

17. The apparatus according to claim 15, further comprising:
a prompting unit, configured to prompt a user to log in the server with another terminal to acquire the content to be shared.

18. The apparatus according to claim 15, wherein the indicator of the second terminal is included in a push request sent from the first terminal to the server, and the server pushes the content to be shared to the second terminal according to the push request.

19. The apparatus according to claim 15, further comprising a list displaying module configured to display the terminal list selection of the second terminal.

20. The apparatus according to claim 15, wherein each of the terminals in the terminal list and the first terminal log in the server with the same user account.

21. The apparatus according to claim 15, wherein the first terminal logs in the server with a first user account and any one of the terminals in the terminal list log in the server with a second user account, wherein the second user account is linked to the first user account in a social network.
